(19) United States
(12) Patent Application Publication
(10) Pub. No.: US 2021/0117070 A1
(43) Pub. Date: Apr. 22, 2021

(54) COMPUTER-READABLE RECORDING MEDIUM, COMPUTER APPARATUS, AND METHOD OF CONTROLLING

(71) Applicant: SQUARE ENIX CO., LTD., Tokyo (JP)

(72) Inventors: Kei Muta, Tokyo (JP); Kei Odagiri, Tokyo (JP)

(73) Assignee: SQUARE ENIX CO., LTD., Tokyo (JP)

(21) Appl. No.: 17/033,716

(22) Filed: Sep. 26, 2020

(30) Foreign Application Priority Data
Oct. 18, 2019 (JP) 2019-191467

(51) Int. Cl. G06F 3/0481; G06F 3/0484

(52) U.S. Cl. CPC G06F 3/04815; G06F 3/04842

(57) ABSTRACT

To provide a program capable of improving user operability.

An object is determined as an object selectable if a position on a generated image, the position being specified through the input device and a position the object on a captured image have the predetermined relationship and if an obstacle object that blocks a line of sight from a reference point between the reference point and the object is not present.

### CROSS REFERENCE TO RELATED APPLICATION

The present disclosure relates to subject matter contained in Japanese Patent Application No. 2019-191467, filed on Oct. 18, 2019, the disclosure of which is expressly incorporated herein by reference in its entirety.

### TECHNICAL FIELD

The present invention relates to a computer-readable recording medium, a computer apparatus, and a method or controlling.

### BACKGROUND ART

In the related art, there is a program for selecting an object in a virtual space corresponding to a position specified through an input device such as a mouse. There is also a program for switching an object to be selected in a preset order when the user presses a predetermined key.

### SUMMARY OF INVENTION

### Technical Problem

However, when the object moves around in the virtual space, it is difficult to specify the moving object. Further, when switching objects according to a predetermined order, it takes time to select an object that the user wants to select when the number of objects is large, which may make the user feel inconvenient.

An object of at least one embodiment of the present invention is to provide a program capable of improving user operability.

### Solution to Problem

According to a non-limiting aspect, a non-transitory computer-readable recording medium including a program that is executed in a computer apparatus comprising an input device, the program causing the computer apparatus to function as: an image generator that generates an image captured by imaging an inside of a three-dimensional virtual space using a virtual camera; a position acquirer that acquires a position on the generated image, the position being specified by a user through the input device; a first determiner that determines whether or not a position of an object in the three-dimensional virtual space on the generated image has a predetermined relationship with the position acquired by the position acquirer; a second determiner that determines whether or not an obstacle object that blocks a line of sight from a reference point between the reference point and the object in the three-dimensional virtual space is present; and a setter that sets the object, which is determined by the first determiner as having the predetermined relationship and is determined by the second determiner as not having the obstacle object, as an object selectable by the user.

According to a non-limiting aspect, A computer apparatus comprising an input device, comprising: an image generator that generates an image captured by imaging an inside of a three-dimensional virtual space using a virtual camera; a position acquirer that acquires a position on the generated image, the position being specified by a user through the input device; a first determiner that determines whether or not a position of an object in the three-dimensional virtual space on the generated image has a predetermined relationship with the position acquired by the position acquirer; a second determiner that determines whether or not an obstacle object that blocks a line of sight from a reference point between the reference point and the object in the three-dimensional virtual space is present; and a setter that sets the object, which is determined by the first determiner as having the predetermined relationship and is determined by the second determiner as not having the obstacle object, as an object selectable by the user.

According to a non-limiting aspect, a control method in a computer apparatus comprising an input device, the control method comprising: generating an image captured by imaging an inside of a three-dimensional virtual space using a virtual camera; acquiring the position on the generated image, the position being specified by a user through the input device; first determining whether or not a position of an object in the three-dimensional virtual space on the generated image has a predetermined relationship with the position acquired by the position acquirer; second determining whether or not an obstacle object that blocks a line of sight from a reference point between the reference point and the object in the three-dimensional virtual space is present; and setting the object, which is determined by the first determining as having the predetermined relationship and is determined by the second determining as not having the obstacle object, as an object selectable by the user.

### Advantageous Effects of Invention

One or more of the above problems can be solved with each embodiment of the present invention.

### BRIEF DESCRIPTION OF THE DRAWINGS

FIG. 1 is a block diagram showing a configuration of a computer apparatus corresponding to at least one of the embodiments of the present invention.

FIG. 2 is a flowchart of a program execution process corresponding to at least one of the embodiments of the present invention.

FIG. 3 is a block diagram showing a configuration of a computer apparatus corresponding to at least one of the embodiments of the present invention.

FIG. 4 is a block diagram showing a configuration of a computer apparatus corresponding to at least one of the embodiments of the present invention.

FIGS. 5A and 5B are diagrams showing an example of a program execution screen corresponding to at least one of the embodiments of the present invention.

FIG. 6 is a block diagram showing a configuration of the computer apparatus corresponding to at least one of the embodiments of the present invention.

FIG. 7 is a flowchart of a program execution process corresponding to at least one of the embodiments of the present invention.

FIG. 8 is a diagram showing an example of a config screen corresponding to at least one of the embodiments of the present invention.

FIGS. 9A to 9D are conceptual diagrams for describing blocking of the line of sight corresponding to at least one of the embodiments of the present invention.

FIGS. 10A to 10D are conceptual diagrams for describing blocking of the line of sight corresponding to at least one of the embodiments of the present invention.

FIG. 11 is a block diagram showing a configuration of a server apparatus corresponding to at least one of the embodiments of the present invention.

FIG. 12 is a flowchart of a program execution process corresponding to at least one of the embodiments of the present invention.

FIG. 13 is a block diagram showing a configuration of a system corresponding to at least one of the embodiments of the present invention.

FIG. 14 is a flowchart of an execution process corresponding to at least one of the embodiments of the present invention.

FIG. 15 is a block diagram showing a configuration of a terminal apparatus corresponding to at least one of the embodiments of the present invention.

FIG. 16 is a flowchart of a program execution process corresponding to at least one of the embodiments of the present invention.

FIG. 17 is a block diagram showing a configuration of a system corresponding to at least one of the embodiments of the present invention.

FIG. 18 is a block diagram showing a configuration of a server apparatus corresponding to at least one of the embodiments of the present invention.

FIG. 19 is a block diagram showing a configuration of a system corresponding to at least one of the embodiments of the present invention.

FIG. 20 is a block diagram showing a configuration of a system corresponding to at least one of the embodiments of the present invention.

### DESCRIPTION OF EMBODIMENTS

Hereinafter, embodiments of the invention will be described with reference to the accompanying drawings. Hereinafter, description relating to effects shows an aspect of the effects of the embodiments of the invention, and does not limit the effects. Further, the order of respective processes that form a flowchart described below may be changed in a range without contradicting or creating discord with the processing contents thereof.

### First Embodiment

An outline of a first embodiment of the present invention will be described. In the following, as the first embodiment, a program executed in a computer apparatus including an input device will be described by way of example.

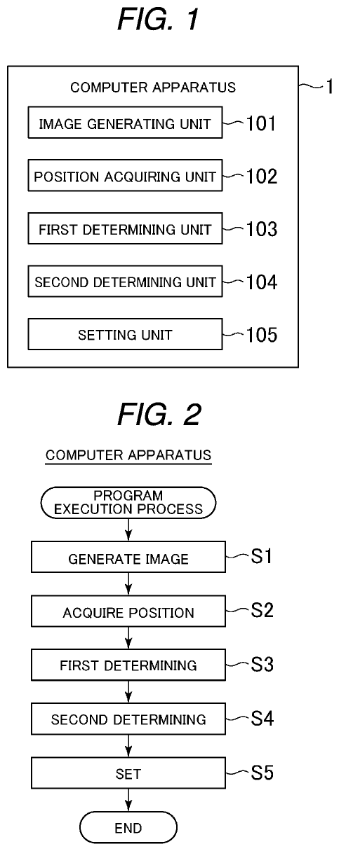

FIG. 1 is a block diagram showing a configuration of a computer apparatus corresponding to at least one of the embodiments of the present invention. A computer apparatus 1 includes at least an image generating unit 101, a position acquiring unit 102, a first determining unit 103, a second determining unit 104, and a setting unit 105.

The image generating unit 101 has a function of generating an image captured by imaging an inside of the three-dimensional virtual space using a virtual camera. The position acquiring unit 102 has a function of acquiring the position on the generated image, which is specified by the user through the input device.

The first determining unit 103 has a function of determining whether or not the position of the object in the three-dimensional virtual space on the generated image has a predetermined relationship with the position acquired by the position acquiring unit 102. The second determining unit 104 has a function of determining whether or not there is an obstacle object that blocks the line of sight from a reference point between the reference point and the object in the three-dimensional virtual space.

The setting unit 105 has a function of setting an object, which is determined by the first determining unit 103 as having the predetermined relationship and is determined by the second determining unit 104 as having no obstacle object, as an object selectable by the user.

Next, a program execution process in the first embodiment of the present invention will be described. FIG. 2 is a flowchart of a program execution process corresponding to at least one of the embodiments of the present invention.

The computer apparatus 1 generates the image captured by imaging the inside of the three-dimensional virtual space using the virtual camera (step S1). Next, the computer apparatus 1 acquires the position on the generated image, which is specified by the user through the input device (step S2).

Next, the computer apparatus 1 determines whether or not the position of the object in the three-dimensional virtual space on the generated image has a predetermined relationship with the position acquired in step S2 (step S3). Next, the computer apparatus 1 determines whether or not there is an obstacle object that blocks the line of sight from the reference point between the reference point and the object in the three-dimensional virtual space. (step S4).

Next, the computer apparatus 1 sets an object, which is determined by the first determining unit 103 as having the predetermined relationship and is determined by the second determining unit 104 as having no obstacle object, as an object selectable by the user (step S5), and the process is terminated.

As an aspect of the first embodiment, operability of the user can be improved.

In the first embodiment, the “input device” refers to, for example, a device for providing data, information, instructions, or the like, to a computer apparatus or a program. The “computer apparatus” refers to, for example, a mobile phone, a smartphone, a tablet computer, a personal computer, a portable game console, a stationary game console, a wearable terminal, or the like, which is capable of execution process of a program.

In the first embodiment, the “three-dimensional virtual space” means, for example, a three-dimensional space defined by a computer, and more specifically, includes a three-dimensional space drawn by a program or a space constituted by using captured images for the real world. The “object” means, for example, an object that constitutes a virtual space, and specifically includes disposed objects such as characters, vehicles, weapons, armor, items, avatars, and treasure boxes. The “position on the image” refers to, for example, coordinates in a coordinate system in which the image captured by the virtual camera is a plane.

In the first embodiment, the “reference point” refers to, for example, a point set as the reference in the three-dimensional virtual space, which is connected to the points forming at least a part of the object. The “line of sight of the virtual camera” refers to, for example, the visual axis of the virtual camera that captures an image of the virtual space. “Blocking the line of sight” refers to, for example, there being an opaque object on a straight line connecting the viewpoint of the virtual camera to an object as a subject. “Opaque” means, for example, that physical passing through an object is not permitted, and the concept of the object includes light as well as physical things.

### Second embodiment

Next, an outline of a second embodiment of the present invention will be described. In the following, as the second embodiment, a program executed in a computer apparatus including an input device will be described by way of example.

As a configuration of a computer apparatus in the second embodiment, that shown in the block diagram of FIG. 1 can be adopted within a necessary range. Further, as a flowchart of the program execution process in the second embodiment, that shown in the flowchart of FIG. 2 can be adopted within a necessary range.

In the second embodiment, it is desirable that the reference point in the second determining unit 104 is a viewpoint of a virtual camera that images the inside of the three-dimensional virtual space.

As an aspect of the second embodiment, operability of the user can be improved.

As an aspect of the second embodiment, since the reference point in the second determining unit 104 is the viewpoint of the virtual camera that images the inside of the three-dimensional virtual space, only visible objects can be selected in the captured image, and the user can operate intuitively, which makes it possible to improve the operability.

In the second embodiment, for each of “input device”, “computer apparatus”, “three-dimensional virtual space”, “object”, “position on the image”, “reference point”, “line of sight of virtual camera”, and “blocking the line of sight”, the contents described in the first embodiment can be adopted within a necessary range.

### Third Embodiment

Next, an outline of a third embodiment of the present invention will be described. In the following, as the third embodiment, a program executed in a computer apparatus including an input device will be described by way of example.

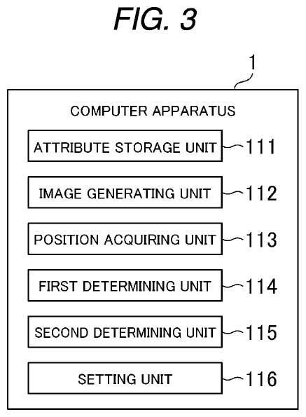

FIG. 3 is a block diagram showing a configuration of a computer apparatus corresponding to at least one of the embodiments of the present invention. A computer apparatus 1 includes at least an attribute storage unit 111, an image generating unit 112, a position acquiring unit 113, a first determining unit 114, a second determining unit 115, and a setting unit 116.

The attribute storage unit 111 has a function of storing the attribute of each object, which indicates whether or not the object in the three-dimensional virtual space can be selected. The image generating unit 112 has a function of generating an image captured by imaging the inside of the three-dimensional virtual space using a virtual camera. The position acquiring unit 113 has a function of acquiring the position on the generated image, which is specified by the user through the input device.

The first determining unit 114 has a function of determining whether or not the position of the object in the three-dimensional virtual space on the generated image has a predetermined relationship with the position acquired by the position acquiring unit 113. The second determining unit 115 has a function of determining whether or not there is an obstacle object that blocks the line of sight from a reference point between the reference point and the object in the three-dimensional virtual space.

The setting unit 116 has a function of setting an object, which is determined by the first determining unit 114 as having the predetermined relationship and is determined by the second determining unit 115 as having no obstacle object, as an object selectable by the user.

In the third embodiment, it is desirable that an object having an attribute indicating that it is selectable is a selectable object.

As the flowchart of a program execution process in the third embodiment, that shown in the flowchart of FIG. 2 can be adopted within a necessary range.

As an aspect of the third embodiment, operability of the user can be improved.

As an aspect of the third embodiment, with the facts that the computer apparatus includes the attribute storage unit 111 and the object having the attribute indicating that it is selectable is a selectable object, an object having an attribute indicating that it is not selectable can be excluded from a selection candidate and only the selectable object can be selected without making a mistake, and thus operability of the user can be improved.

In the third embodiment, for each of “input device”, “computer apparatus”, “three-dimensional virtual space”, “object”, “position on the image”, “reference point”, “line of sight of virtual camera”, and “blocking the line of sight”, the contents described in the first embodiment can be adopted within a necessary range.

### Fourth Embodiment

Next, an outline of a fourth embodiment of the present invention will be described. In the following, as the fourth embodiment, a program executed in a computer apparatus including an input device will be described by way of example.

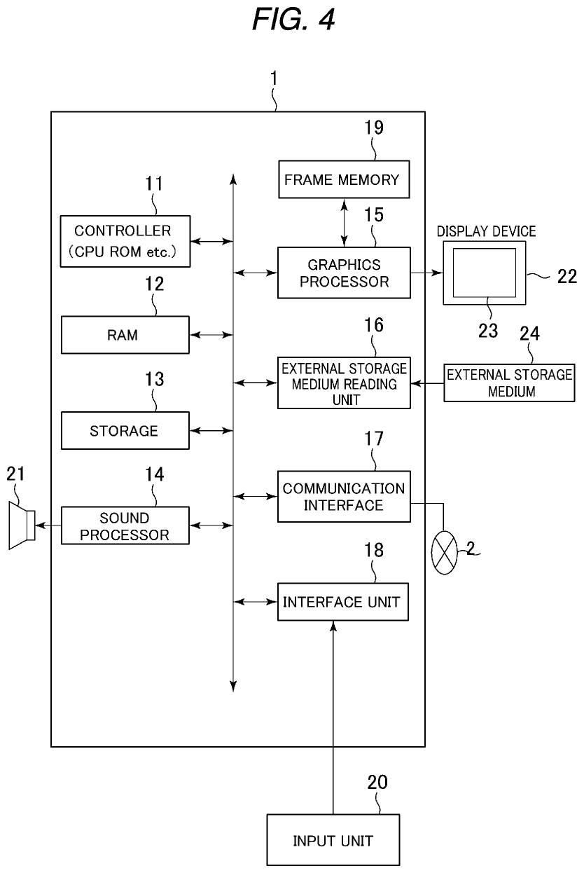

FIG. 4 is a block diagram showing a configuration of a computer apparatus corresponding to at least one of the embodiments of the present invention. The computer apparatus 1 includes at least a controller 11, a random access memory (RAM) 12, a storage 13, a sound processor 14, a graphics processor 15, an external storage medium reading unit 16, a communication interface 17, and an interface unit 18, and are each connected by internal buses.

The controller 11 includes a central processing unit (CPU) and a read only memory (ROM). The controller 11 executes a program stored in the storage 13 or the external storage medium 24 to control the computer apparatus 1. The controller 11 also includes an internal timer that measures time. The RAM 12 is a work area of the controller 11. The storage 13 is a storage area for storing programs and data.

The external storage medium reading unit 16 can read the stored program from the external storage medium 24 such as a DVD-ROM, a CD-ROM, or a cartridge ROM in which the program is stored. The external storage medium 24 stores, for example, programs and data. The programs and data are read from the external storage medium 24 by the external storage medium reading unit 16 and loaded into the RAM 12.

The controller 11 reads programs and data from the RAM 12 and performs processing. The controller 11 processes programs and data loaded in the RAM 12 to output a sound output instruction to the sound processor 14 and a drawing command to the graphics processor 15.

The sound processor 14 is connected to a sound output device 21, which is a speaker. When the controller 11 outputs the sound output instruction to the sound processor 14, the sound processor 14 outputs a sound signal to the sound output device 21.

The graphics processor 15 is connected to a display device 22. The display device 22 has a display screen 23. When the controller 11 outputs the drawing command to the graphics processor 15, the graphics processor 15 develops an image in a frame memory (frame buffer) 19 and outputs a video signal for displaying the image on the display screen 23. The graphics processor 15 executes drawing of one image in frame units. One frame time of the image is, for example, 1/30 seconds. The graphics processor 15 is responsible for some kinds of the arithmetic processing relating to the drawing performed only by the controller 11, and has a role of distributing the load of the entire system.

An input unit 20 (for example, a mouse or a keyboard) can be connected to the interface unit 18. Input information from the input unit 20 by the user is stored in the RAM 12, and the controller 11 executes various kinds of arithmetic processing based on the input information. Alternatively, it is also possible to connect a storage medium reading device to the interface unit 18 and read the programs and data from the memory or the like. Further, the display device 22 having a touch panel may be used as the input unit 20.

The communication interface 17 can be connected to a communication network 2 wirelessly or by wire, and can transmit and receive information to and from other computer apparatuses through the communication network 2.

The computer apparatus 1 may include a sensor such as a proximity sensor, an infrared sensor, a gyro sensor, or an acceleration sensor. In addition, the computer apparatus 1 may include a lens and include an image capturing unit that captures an image through the lens.

Next, a program execution screen according to the fourth embodiment of the present invention will be described. In the fourth embodiment, as an example, a computer apparatus including a keyboard and a mouse as the input unit 20 will be described. Further, as an example of the program, a field movement type game program, which is capable of moving a user object (hereinafter, also referred to as a player character) operated by a user in a three-dimensional virtual space, will be exemplified.

### Execution Screen

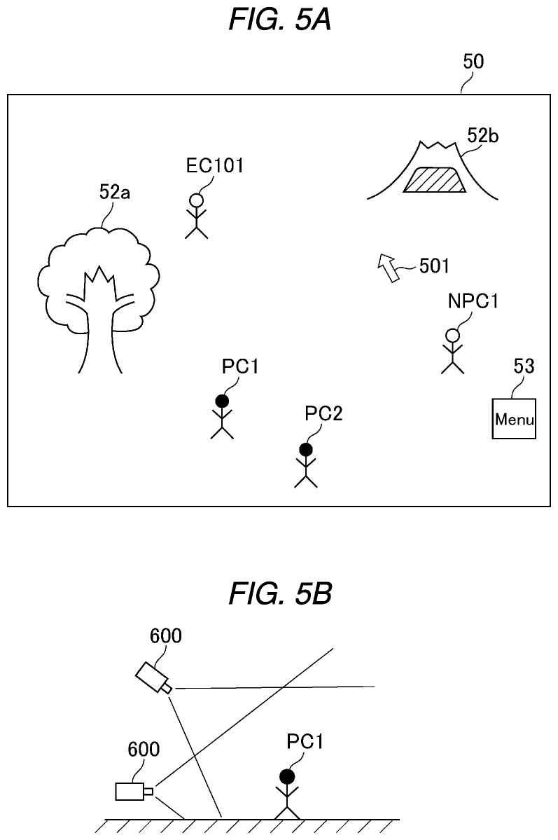

FIGS. 5A and 5B are diagrams showing an example of a program execution screen corresponding to at least one of the embodiments of the present invention. A game screen 50 is displayed on the display screen 23 of the computer apparatus 1. The game screen 50 is an image of a three-dimensional virtual space captured by a virtual camera.

As shown in FIG. 5A, on the game screen 50, user objects PC1 and PC2 operated by the user, an enemy object EC101, a non-player object NPC1 controlled by the computer apparatus, objects 52a and 52b disposed on a game field, a menu object 53, a cursor 501 linked with mouse operation, and the like are displayed. All the objects present on the game field may not move from the same position, or may move around randomly.

The user can move the cursor 501 by operating the mouse. The user can attack the enemy object by hovering over and clicking the cursor 501 on the enemy object EC101 or the like. Further, when the field where there is no object is clicked, the user object PC1 can be controlled to move to the clicked position. Different commands may be set for the left and right click operations.

There may be a plurality of user objects PC1. For example, adventure may be taken in a virtual space by forming a party or a guild (hereinafter referred to as a guild, or the like), including the user object PC2 operated by another user and a character controlled by the computer apparatus but acting as a friend of the user object PC1.

By clicking the menu object 53, game settings can be changed. A config screen for changing game settings, which will be described later, may be displayed.

Next, an image captured by the virtual camera will be described. As shown in FIG. 5B, the virtual camera 600 can be displaced at any position in the virtual space. For example, image capturing may be performed from a bird's eye viewpoint with the visual axis of the virtual camera directed toward the ground (field) as if the user object PC1 is looked down from above, or may be performed with the visual axis of the virtual camera directed in the horizontal direction with respect to the ground at the same height as the line of sight of the user object PC1. Further, image capturing may be performed with the visual axis of the virtual camera directed in the air direction opposite to the ground.

The viewpoint of the virtual camera may be substantially the same as the viewpoint of the user object PC1, or the visual axis of the virtual camera may be oriented in a direction different from the visual axis of the user object PC1. The position of the virtual camera can be changed based on the operation of the user.

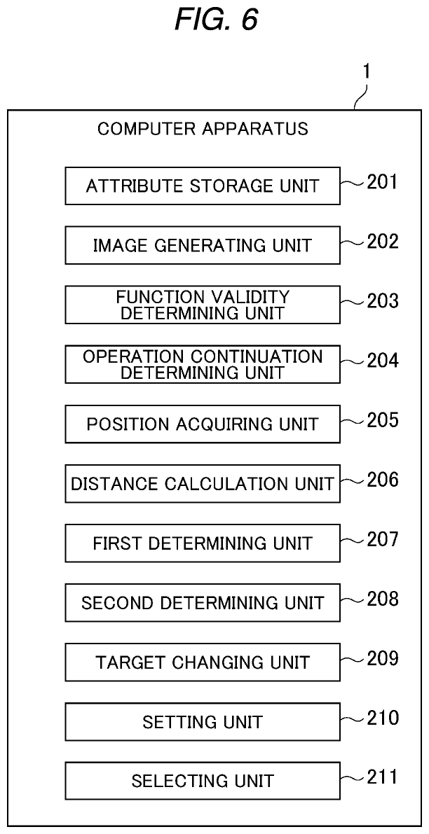

Next, functions of the computer apparatus 1 will be described. FIG. 6 is a block diagram showing a configuration of the computer apparatus corresponding to at least one of the embodiments of the present invention. The computer apparatus 1 includes at least an attribute storage unit 201, an image generating unit 202, a function validity determining unit 203, an operation continuation determining unit 204, a position acquiring unit 205, a distance calculation unit 206, a first determining unit 207, a second determining unit 208, a target changing unit 209, a setting unit 210, and a selecting unit 211.

The attribute storage unit 201 has a function of storing the attribute of each object, which indicates whether or not the object in the three-dimensional virtual space can be selected. The image generating unit 202 has a function of generating an image captured by imaging the inside of the three-dimensional virtual space using a virtual camera. The function validity determining unit 203 has a function of determining whether or not a target function is valid. The operation continuation determining unit 204 has a function of determining whether or not a predetermined input operation by the user is continuing. The position acquiring unit 205 has a function of acquiring the position on the generated image, which is specified by the user through the input device.

The distance calculation unit 206 has a function of calculating the distance between the position acquired by the position acquiring unit 205 and the position of the object on the image. The first determining unit 207 has a function of determining whether or not the position of the object in the three-dimensional virtual space on the generated image has a predetermined relationship with the position acquired by the position acquiring unit 205. The second determining unit 208 has a function of determining whether or not there is an obstacle object that blocks the line of sight from a reference point between the reference point and the object in the three-dimensional virtual space.

When it is determined that the object does not satisfy the predetermined condition, the target changing unit 209 has a function of setting an object other than the object that has been the target of the determination as the determination target. The setting unit 210 has a function of setting an object, which is determined by the first determining unit 207 as having the predetermined relationship and is determined by the second determining unit 208 as having no obstacle object, as an object selectable by the user. The selecting unit 211 has a function of selecting an object that satisfies the predetermined condition.

Next, a program execution process will be described. As a premise, an attribute indicating whether or not selection can be made for each object present in the virtual space is stored by the attribute storage unit 201 of the computer apparatus 1. That is, objects are distinguished in advance between object that are selectable and objects that are not selectable. In addition, an image captured by imaging the inside of the three-dimensional virtual space using the virtual camera is generated by the image generating unit 202, and the captured image is displayed on the display screen 23 of the computer apparatus 1.

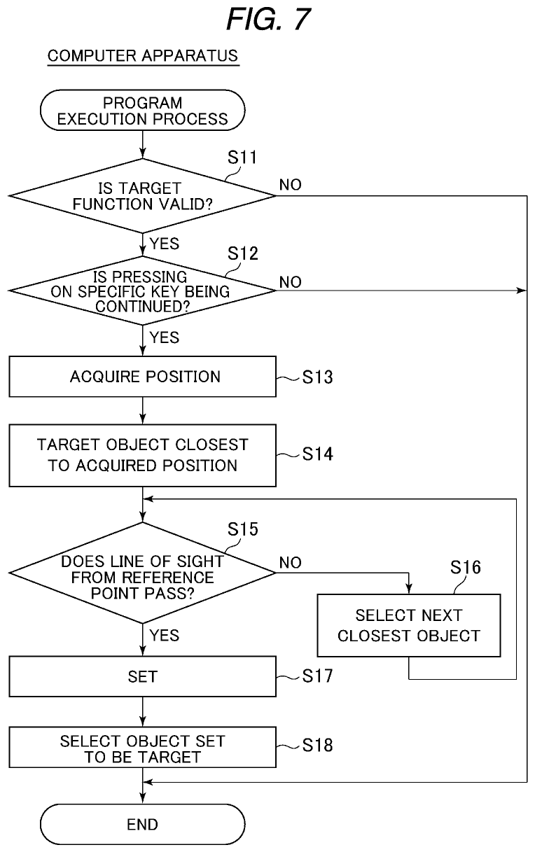

FIG. 7 is a flowchart of a program execution process corresponding to at least one of the embodiments of the present invention. The computer apparatus 1 determines whether or not the target function is valid (step S11). To make the target function valid, the function may be made valid on the setting (config) screen in advance.

### Setting (Config) Screen

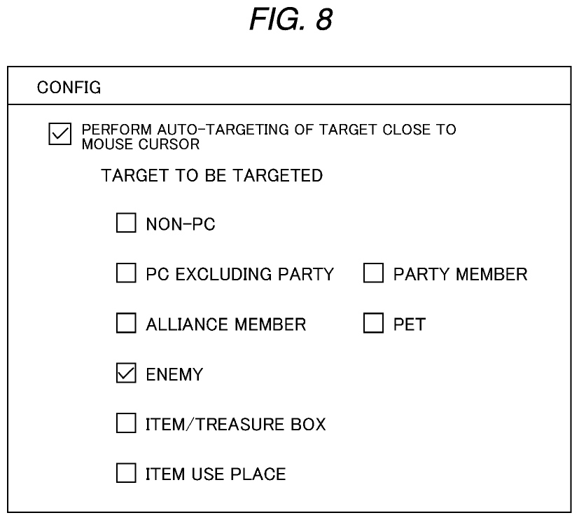

FIG. 8 is a diagram showing an example of a config screen corresponding to at least one of the embodiments of the present invention. The config screen is displayed by clicking the menu object 53 in the game screen 50. Functions that can be made valid or invalid are displayed on the config screen. An example of the functions is an auto-target function for selecting an object without depending on a user operation, as shown in FIG. 8.

The auto-target function can be made valid by checking a check box located to the left of the words “perform auto-targeting of the target close to a mouse cursor”. Further, as an example, a target to be targeted (NPC, PC, pet, alliance member, and the like) may be selected. As a result, setting can be made to match the preference of the user and thus operability of the user can be improved.

The setting may be updated by checking the check box, or the setting may be saved by pressing the save button. Alternatively, the target to be targeted may be assigned to each key of the keyboard by using the check box to make the auto-target function valid or invalid. Assigning to a key refers to, for example, assigning “item/treasure box” to the E key and “pet” to the Z key.

The flowchart of FIG. 7 is referred to again. When the target function is invalid (NO in step S11), the process is terminated. When the target function is valid (YES in step S11), the computer apparatus 1 determines whether or not the predetermined input operation is being continued by the operation continuation determining unit 204 (step S12). Examples of the predetermined input operation include pressing of a specific key, continuous click operation at short intervals, and the like.

When it is determined that the predetermined input operation does not continue (NO in step S12), the process is terminated. When it is determined that the predetermined input operation is continuing (YES in step S12), the computer apparatus 1 acquires the position on the generated image, which is specified by the user through the input device, by the position acquiring unit 205, (step S13). Here, as an example, the input device is a mouse, and the position acquired in step S13 is the position specified by the mouse, that is, the position coordinate specified by the cursor 501 on the game screen 50.

Next, the computer apparatus 1 extracts an object having a predetermined relationship with the position acquired by the position acquiring unit 205, by the first determining unit 207. The predetermined relationship refers to, for example, a relationship in which an object is located within a predetermined range from the position acquired in step S13. The predetermined range may be a range of a two-dimensional plane or in a three-dimensional space. The computer apparatus 1 calculates the distance between the position acquired by the position acquiring unit 205 and the position of the extracted object on the image, by the distance calculation unit 206, and sets an object located at the acquired position, that is, closest to the position of the cursor 501 as a determination target of the second determining unit 208 (step S14).

Next, the computer apparatus 1 determines whether or not there is an obstacle object that blocks the line of sight from the reference point between the reference point and the object in the three-dimensional virtual space. (step S15). Here, as an example of the reference point, a viewpoint of a virtual camera that images the inside of a three-dimensional virtual space is taken.

### Blocking Line of Sight from Reference Point

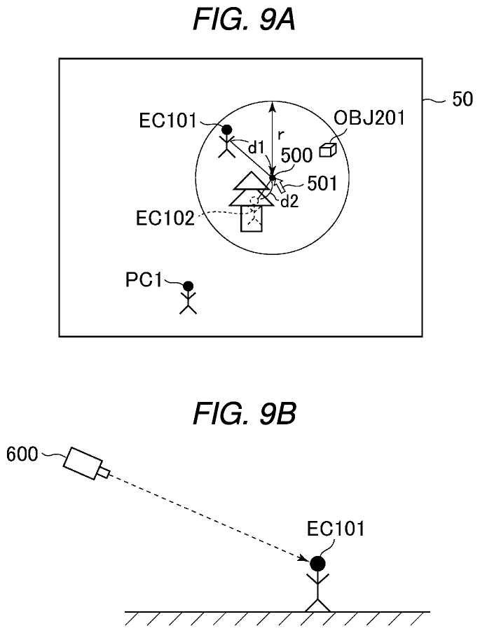

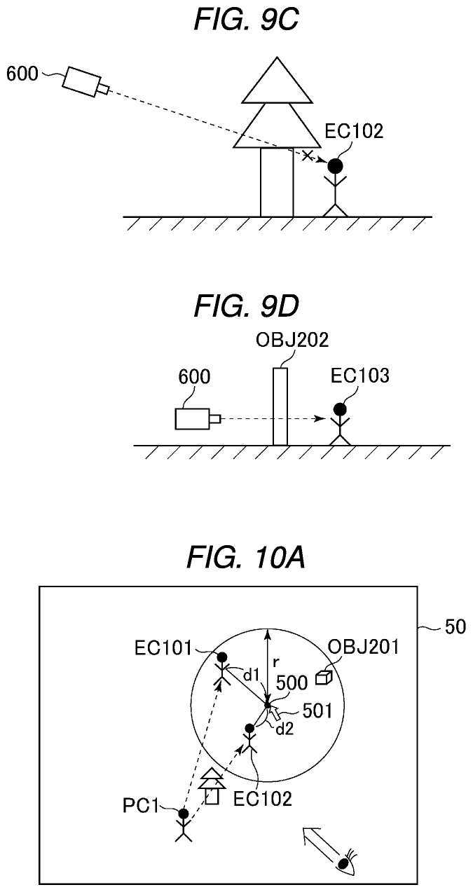

Here, blocking the line of sight from the reference point will be described. FIGS. 9A to 9D are conceptual diagrams for describing blocking of the line of sight corresponding to at least one of the embodiments of the present invention. FIG. 9A is a diagram describing selection of an object on the game screen 50. In the figure, the line of sight of the virtual camera, which is the reference point, is directed in the field direction, and is displayed as a bird's eye view.

Objects included in a circle having a radius r from the position where the cursor 501 is present are an object group of the targets to be selected. In the figure, there are enemy objects EC101, EC102, and an object OBJ201 within the range.

Regarding the distance from the cursor 501 to each enemy object, d2 is shorter than d1. In this case, when the enemy object closest to the position of the cursor 501 is to be selected, the enemy object EC102 is selected.

Here, it will be described whether or not the lines of sight from the virtual camera to the enemy objects EC101 and EC102 is blocked. FIG. 9B is a diagram illustrating the line of sight of the virtual camera to the enemy object EC101. The line of sight from the virtual camera 600 to the enemy object EC101 located on the field is not blocked by another object. That is, there is no other object on a line segment connecting the viewpoint of the virtual camera 600 and a part of the enemy object EC101 (the head portion of the character in the figure). This state is called “the line of sight passes”.

On the other hand, FIG. 9C is a diagram illustrating the line of sight of the virtual camera to the enemy object EC102. As shown in FIG. 9A, the enemy object EC102 is hidden by a tree object, and the appearance thereof cannot be directly confirmed in the image captured by the virtual camera. That is, the line of sight from the virtual camera 600 is blocked by the tree object. As described above, the state where the line of sight is blocked by another object present on the line segment that connects the viewpoint of the virtual camera and a part (head portion) of the enemy object EC102 is called “the line of sight does not pass”.

However, when the line of sight does not pass on the line segment connecting the reference point and the predetermined part of the enemy object EC102, but the line of sight passes on a line segment connecting the reference point and the other part that is different from the predetermined part of the enemy object EC102, the result may be regarded as the line of sight passing. That is, when even a part of the enemy object EC102 can be visible, it may be determined that the line of sight passes.

Whether or not the line of sight passes may be made to depend on the transparency of other objects located on the line segment of the line of sight (or the visual axis). FIG. 9D is a diagram illustrating the line of sight of the virtual camera when there is a transparent object. The line of sight of the virtual camera 600 is, for example, directed in the horizontal direction with respect to the ground. Further, there is an object OBJ202 between the viewpoint of the virtual camera 600 and the enemy object EC103.

Here, when the object OBJ202 is a transparent object such as glass, it may be determined that the line of sight of the virtual camera 600 passes to the enemy object EC103. In addition, determination may be made as to whether or not the line of sight passes according to the transmittance of the object OBJ202. By doing so, it is possible to increase the preference of the user for moving the virtual camera to discover enemy objects, items, and the like.

By setting the viewpoint of the virtual camera as the reference point, the target for determining whether or not the line of sight passes can be paraphrased as a visible object in the image captured by the virtual camera.

The flowchart of FIG. 7 is referred to again. When the line of sight does not pass from the reference point (NO in step S15), the computer apparatus 1 sets an object other than the object that has been the target of the determination as a determination target by the target changing unit 209 (step S16). More specifically, an object present at a position next closest to the position acquired in step S13 is set as a determination target. Then, it is again determined whether or not the line of sight passes from the reference point (step S15). The target object is changed in step S16 but when the line of sight does not pass from the reference point with respect to all the objects having a predetermined relationship with the position acquired by the position acquiring unit 205, the process may be terminated assuming that there is no selectable object.

When the line of sight passes from the reference point (YES in step S15), the computer apparatus 1 sets the object that has been the determination target in step S15 as an object that is selectable by the user (step S17). Next, the computer apparatus 1 automatically sets the set object to the selected state by the selecting unit 211 (step S18), and the process is terminated.

As an example of the fourth embodiment, when the object as the determination target does not satisfy a predetermined condition, the next closest object is selected, but the present invention is not limited thereto. For example, the target may be changed based on a user operation.

As an example of the fourth embodiment, the selection state is automatically set after being set as a selectable object, but the present invention is not limited thereto. For example, the display mode may be changed such that the target candidate is emphasized and displayed without being selected. Alternatively, the selection may be made based on an operation instruction of the user.

As an example of the fourth embodiment, the line-of-sight direction of the virtual camera may be different from the line-of-sight direction of the character operating according to the operation instruction of the user.

As an example of the fourth embodiment, a case has been described in which the target function is made valid when setting is performed on the config screen and the predetermined input operation is continued, but the present invention is not limited thereto. For example, validity may be made only by setting the config screen, or may be made only by continuing a predetermined input operation.

As an example of the fourth embodiment, the virtual space has been described, but the present invention can be applied to the field of augmented reality (AR) that incorporates information of the real world.

As an example of the fourth embodiment, the game program has been described, but the present invention is not limited to games and applicable genres are not limited.

As an example of the fourth embodiment, the reference point for determining whether or not the line of sight passes is the viewpoint of the virtual camera, but the present invention is not limited thereto. For example, the reference point may be set for an object.

As an example of the fourth embodiment, an example in which a mouse is used as the input device has been described, but the present invention is not limited thereto. For example, a wearable device that detects the movement of the body of the user may be adopted as the input device. A device that reads the movement of the eyeball as the movement of the body may be adopted. Alternatively, a device that listens to the voice being uttered and operates the input position may be adopted.

### Set Reference Point for Object

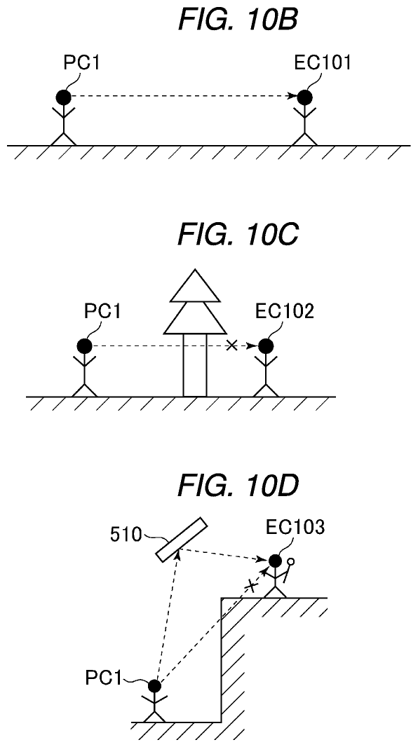

A case where the reference point is set for the user object PC1 will be described. FIGS. 10A to 10D are conceptual diagrams for describing blocking of the line of sight corresponding to at least one of the embodiments of the present invention. FIG. 10A is a diagram illustrating selection of an object on the game screen 50. In the figure, the line of sight of the virtual camera is directed in the field direction, and is displayed as a bird's eye view.

Objects included in a circle having a radius r from the position where the cursor 501 is present are an object group of the targets to be selected. In the figure, there are enemy objects EC101, EC102, and an object OBJ201 within the range.

Regarding the distance from the cursor 501 to each enemy object, d2 is shorter than d1. In this case, when the enemy object closest to the position of the cursor 501 is selected, the enemy object EC102 is selected.

Here, it will be described whether or not the lines of sight from the user object PC1 to the enemy objects EC101 and EC102 is blocked. FIGS. 10B and 10C are diagrams viewed from the direction of an eye object shown in FIG. 10A.

FIG. 10B is a diagram illustrating the line of sight of the user object PC1 to the enemy object EC101. The line of sight from the user object PC1 to the enemy object EC101 located on the field is not blocked by another object. That is, there is no other object on a line segment connecting the viewpoint of the user object PC1 and a part of the enemy object EC101 (the head portion of the character in the figure), and the line of sight passes.

On the other hand, FIG. 10C is a diagram illustrating the line of sight of the user object PC1 to the enemy object EC102. As shown in FIG. 10A, the enemy object EC102 is located in the depth direction of a tree object when viewed from the user object PC1. Therefore, the appearance cannot be directly confirmed in the image captured by the virtual camera. That is, the line of sight from the user object PC1 is blocked by the tree object, and the line of sight does not pass.

The concept of height may be taken into consideration when determination is made whether or not the line of sight passes. FIG. 10D is a diagram illustrating the line of sight of the user object PC1 when there is the enemy object EC103 at a position higher than the standing position of the user object PC1. The line of sight of the user object PC1 is blocked by the wall surface, and the enemy object EC103 cannot be visible from the user object PC1. That is, in this state, the line of sight of the user object PC1 does not pass to the enemy object EC103.

On the other hand, there may be an object such as a mirror that reflects the line of sight. For example, when the object 510 is an object having a property of reflecting a light ray such that the incident angle and the reflection angle are equal to each other, such as a mirror, determination may be made that the line of sight of the user object PC1 passes to the enemy object EC103. Similarly, when visibility is possible by reflection on the water surface, determination may be made that the line of sight has passed. This makes it possible to select only the objects that the user object can view in the virtual space, which can make the virtual space feel more realistic and can enhance the immersive feeling of the user.

As an example of the fourth embodiment, the example has been described in which the reference point is set for the user object, but the present application is not limited thereto. For example, the reference point may be set for the enemy object, or the reference point may be set for the stone object displaced in the virtual space. By changing the reference point to be set, operability of the user can be changed and preference can be improved.

As an aspect of the fourth embodiment, operability of the user can be improved.

As an aspect of the fourth embodiment, since the reference point in the second determining unit 208 is the viewpoint of the virtual camera that images the inside of the three-dimensional virtual space, only visible objects can be selected in the captured image, and the user can operate intuitively, which makes it possible to improve the operability.

As an aspect of the fourth embodiment, since the reference point in the second determining unit 208 is the viewpoint of the character that operates according to the operation instruction of the user in the three-dimensional virtual space, only objects visible by the user object in the virtual space can be selected, the virtual space can be made to feel more realistic, and immersive feeling of the user can be enhanced.

As an aspect of the fourth embodiment, with the facts that the computer apparatus includes the attribute storage unit 201 and the object having the attribute indicating that it is selectable is a selectable object, an object having an attribute indicating that it is not selectable can be excluded from a selection candidate and only the selectable object can be selected without making a mistake, and thus operability of the user can be improved.

As an aspect of the fourth embodiment, since setting of the object by the setting unit 210 can be implemented only when a predetermined condition is satisfied, setting can be made to match the preference of the user, and thus operability of the user can be improved.

As an aspect of the fourth embodiment, since setting of the object can be implemented by setting the attribute indicating whether or not implementation of the setting unit 210 is possible to be implementable, setting can be made to match the preference of the user and thus user operability can be improved.

As an aspect of the fourth embodiment, since setting of the object can be implemented by continuing the predetermined input operation by the user, setting can be made to match the preference of the user, and thus operability of the user can be improved.

As an aspect of the fourth embodiment, since the line-of-sight direction of the virtual camera and the line-of-sight direction of the character operating by the operation instruction of the user in the three-dimensional virtual space are different, the state of the user character can be objectively visible, and the visibility of the user can be improved, for example, the state behind the character can be visible.

As an aspect of the fourth embodiment, since the distance calculation unit 206 and the selecting unit 211 selecting an object are included, the operation of the user can be assisted, the operation load can be reduced, and the operability of the user can be improved.

As an aspect of the fourth embodiment, the unit that switches the selection to an object different from the selected object based on the selecting unit 211 and the input operation of the user is included, and thus the selection can be switched at the timing of the user, and the operability of the user can be improved.

In the fourth embodiment, for each of “input device”, “computer apparatus”, “three-dimensional virtual space”, “object”, “position on the image”, “reference point”, “line of sight of virtual camera”, and “blocking the line of sight”, the contents described in the first embodiment can be adopted within a necessary range.

In the fourth embodiment, “continuation of a predetermined input operation” refers to, for example, continuously performing a predetermined operation, or repeating the same operation intermittently at a predetermined interval. The “bird's eye viewpoint” refers to, for example, a viewpoint that looks down on the virtual space from a high position.

### Fifth Embodiment

An outline of a fifth embodiment of the present invention will be described. In the following, as the fifth embodiment, a program will be described that is executed in a server apparatus of a system including a terminal apparatus having an input device and the server apparatus connectable to the terminal apparatus by communication by way of example.

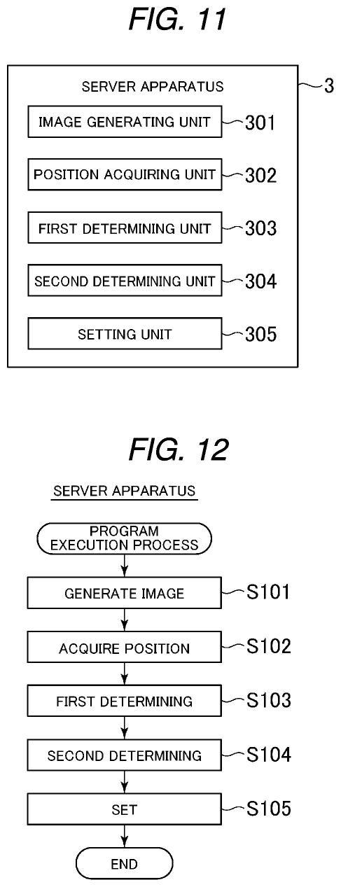

FIG. 11 is a block diagram showing a configuration of a server apparatus corresponding to at least one of the embodiments of the present invention. A server apparatus 3 includes at least an image generating unit 301, a position acquiring unit 302, a first determining unit 303, a second determining unit 304, and a setting unit 305.

The image generating unit 301 has a function of generating an image captured by imaging the inside of the three-dimensional virtual space using a virtual camera. The position acquiring unit 302 has a function of acquiring the position on the generated image, which is specified by the user through the input device.

The first determining unit 303 has a function of determining whether or not the position of the object in the three-dimensional virtual space on the generated image has a predetermined relationship with the position acquired by the position acquiring unit 302. The second determining unit 304 has a function of determining whether or not there is an obstacle object that blocks the line of sight from a reference point between the reference point and the object in the three-dimensional virtual space.

The setting unit 305 has a function of setting an object, which is determined by the first determining unit 303 as having the predetermined relationship and is determined by the second determining unit 304 as having no obstacle object, as an object selectable by the user.

Next, a program execution process according to the fifth embodiment of the present invention will be described. FIG. 12 is a flowchart of a program execution process corresponding to at least one of the embodiments of the present invention.

The server apparatus 3 generates the image captured by imaging the inside of the three-dimensional virtual space using the virtual camera (step S101). Next, the server apparatus 3 acquires the position on the generated image, which is specified by the user through the input device (step S102).

Next, the server apparatus 3 determines whether or not the position of the object in the three-dimensional virtual space on the generated image has a predetermined relationship with the position acquired in step S102 (step S103). Next, the server apparatus 3 determines whether or not there is an obstacle object that blocks the line of sight from the reference point between the reference point and the object in the three-dimensional virtual space. (step S104).

Next, the server apparatus 3 sets an object, which is determined by the first determining unit 303 as having the predetermined relationship and is determined by the second determining unit 304 as having no obstacle object, as an object selectable by the user (step S105), and the process is terminated.

As an aspect of the fifth embodiment, operability of the user can be improved.

In the fifth embodiment, for each of “input device”, “three-dimensional virtual space”, “object”, “position on the image”, “reference point”, “line of sight of virtual camera”, and “blocking the line of sight”, the contents described in the first embodiment can be adopted within a necessary range.

In the fifth embodiment, the “terminal apparatus” may refer to, for example, a stationary game console, a portable game console, a wearable terminal, a desktop or laptop personal computer, a tablet computer, a PDA, or the like, and may be a portable terminal such as a smartphone having a touch panel sensor on the display screen. The “server apparatus” refers to, for example, a device that executes a process in response to a request from a terminal apparatus.

### Sixth Embodiment

An outline of a sixth embodiment of the present invention will be described. In the following, as the sixth embodiment, a system will be described that includes a terminal apparatus having an input device and a server apparatus connectable to the terminal apparatus by communication by way of example.

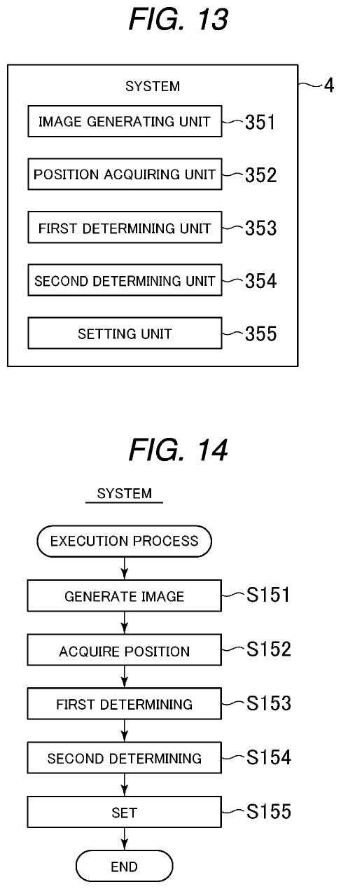

FIG. 13 is a block diagram showing a configuration of a system corresponding to at least one of the embodiments of the present invention. A system 4 includes at least an image generating unit 351, a position acquiring unit 352, a first determining unit 353, a second determining unit 354, and a setting unit 355.

The image generating unit 351 has a function of generating an image captured by imaging the inside of the three-dimensional virtual space using a virtual camera. The position acquiring unit 352 has a function of acquiring the position on the generated image, which is specified by the user through the input device.

The first determining unit 353 has a function of determining whether or not the position of the object in the three-dimensional virtual space on the generated image has a predetermined relationship with the position acquired by the position acquiring unit 352. The second determining unit 354 has a function of determining whether or not there is an obstacle object that blocks the line of sight from a reference point between the reference point and the object in the three-dimensional virtual space.

The setting unit 355 has a function of setting an object, which is determined by the first determining unit 353 as having the predetermined relationship and is determined by the second determining unit 354 as having no obstacle object, as an object selectable by the user.

Next, a program execution process according to the sixth embodiment of the present invention will be described. FIG. 14 is a flowchart of an execution process corresponding to at least one of the embodiments of the present invention.

The system 4 generates the image captured by imaging the inside of the three-dimensional virtual space using the virtual camera (step S151). Next, the system 4 acquires the position on the generated image, which is specified by the user through the input device (step S152).

Next, the system 4 determines whether or not the position of the object in the three-dimensional virtual space on the generated image has a predetermined relationship with the position acquired in step S152 (step S153). Next, the server apparatus 3 determines whether or not there is an obstacle object that blocks the line of sight from the reference point between the reference point and the object in the three-dimensional virtual space. (step S154).

Next, the system 4 sets an object, which is determined by the first determining unit 353 as having the predetermined relationship and is determined by the second determining unit 354 as having no obstacle object, as an object selectable by the user (step S155), and the process is terminated.

As an aspect of the sixth embodiment, operability of the user can be improved.

In the sixth embodiment, for each of “input device”, “three-dimensional virtual space”, “object”, “position on the image”, “reference point”, “line of sight of virtual camera”, and “blocking the line of sight”, the contents described in the first embodiment can be adopted within a necessary range.

In the sixth embodiment, for each of the “terminal apparatus” and the “server apparatus”, the respective contents described in the fifth embodiment can be adopted within a necessary range.

### Seventh Embodiment

An outline of a seventh embodiment of the present invention will be described. In the following, as the seventh embodiment, a program will be described that is executed in a terminal apparatus of a system including the terminal apparatus having an input device and a server apparatus connectable to the terminal apparatus by communication by way of example.

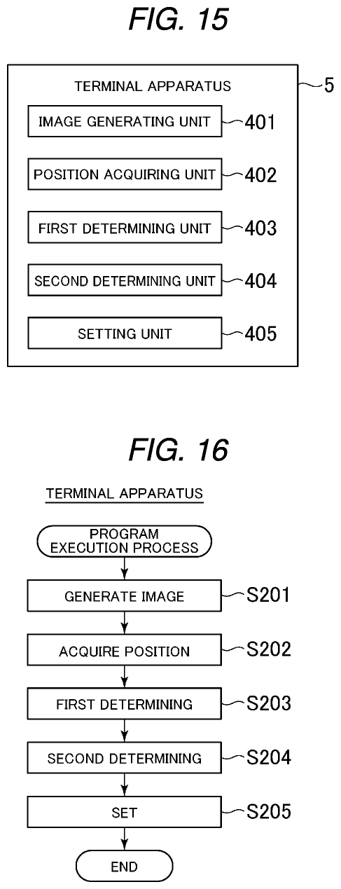

FIG. 15 is a block diagram showing a configuration of a terminal apparatus corresponding to at least one of the embodiments of the present invention. A terminal apparatus 5 includes at least an image generating unit 401, a position acquiring unit 402, a first determining unit 403, a second determining unit 404, and a setting unit 405.

The image generating unit 401 has a function of generating an image captured by imaging the inside of the three-dimensional virtual space using a virtual camera. The position acquiring unit 402 has a function of acquiring the position on the generated image, which is specified by the user through the input device.

The first determining unit 403 has a function of determining whether or not the position of the object in the three-dimensional virtual space on the generated image has a predetermined relationship with the position acquired by the position acquiring unit 402. The second determining unit 404 has a function of determining whether or not there is an obstacle object that blocks the line of sight from a reference point between the reference point and the object in the three-dimensional virtual space.

The setting unit 405 has a function of setting an object, which is determined by the first determining unit 403 as having the predetermined relationship and is determined by the second determining unit 404 as having no obstacle object, as an object selectable by the user.

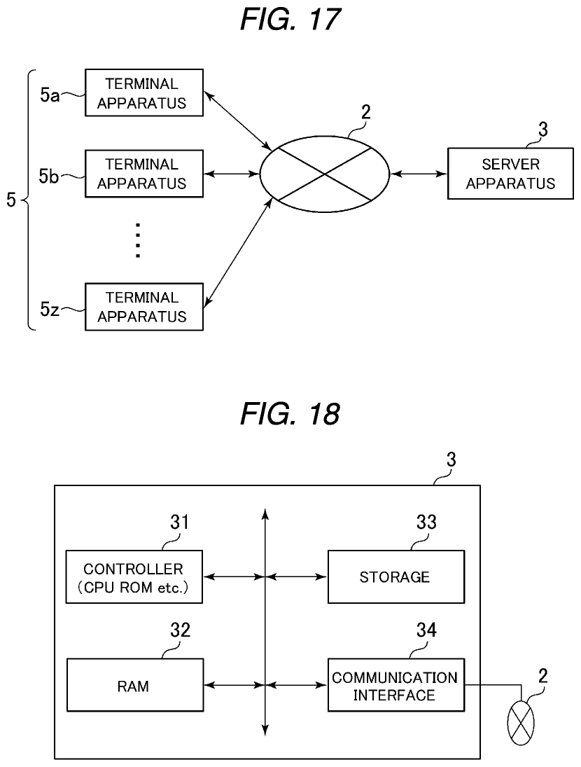

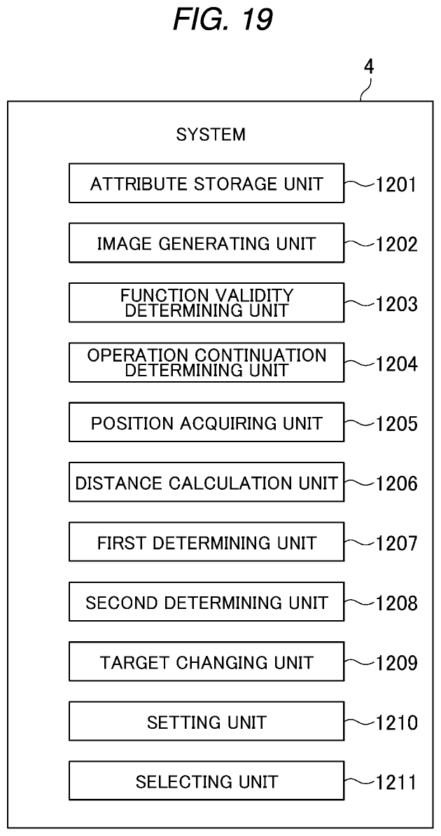

Next, a program execution process according to the seventh embodiment of the present invention will be described. FIG. 16 is a flowchart of a program execution process corresponding to at least one of the embodiments of the present invention.

The terminal apparatus 5 generates the image captured by imaging the inside of the three-dimensional virtual space using the virtual camera (step S201). Next, the terminal apparatus 5 acquires the position on the generated image, which is specified by the user through the input device (step S202).

Next, the terminal apparatus 5 determines whether or not the position of the object in the three-dimensional virtual space on the generated image has a predetermined relationship with the position acquired in step S202 (step S203). Next, the terminal apparatus 5 determines whether or not there is an obstacle object that blocks the line of sight from the reference point between the reference point and the object in the three-dimensional virtual space. (step S204).

Next, the terminal apparatus 5 sets an object, which is determined by the first determining unit 403 as having the predetermined relationship and is determined by the second determining unit 404 as having no obstacle object, as an object selectable by the user (step S205), and the process is terminated.

As an aspect of the seventh embodiment, operability of the user can be improved.

In the seventh embodiment, for each of “input device”, “three-dimensional virtual space”, “object”, “position on the image”, “reference point”, “line of sight of virtual camera”, and “blocking the line of sight”, the contents described in the first embodiment can be adopted within a necessary range.

In the seventh embodiment, for each of the “terminal apparatus” and the “server apparatus” the contents described in the fifth embodiment can be adopted within necessary ranges.

### Eighth Embodiment

Next, an outline of an eighth embodiment of the present invention will be described. In the following, as the eighth embodiment, a system will be described that includes a terminal apparatus having an input device and a server apparatus connectable to the terminal apparatus by communication by way of example.

FIG. 17 is a block diagram showing a configuration of a system corresponding to at least one of the embodiments of the present invention. As illustrated, a system 4 includes a plurality of terminal apparatuses 5 (terminal apparatuses 5a, 5b, . . . , 5z) operated by a plurality of users (users A, B, . . . , Z), a communication network 2, and a server apparatus 3. The terminal apparatuses 5 are connected to the server apparatus 3 through the communication network 2. It should be noted that the terminal apparatus 5 and the server apparatus 3 do not have to be always connected, and may be connected as needed.

FIG. 18 is a block diagram showing a configuration of a server apparatus corresponding to at least one of the embodiments of the present invention. The server apparatus 3 includes a controller 31, a RAM 32, a storage 33, and a communication interface 34, which are connected by internal buses.

The controller 31 includes a CPU and a ROM, executes a program stored in the storage 33, and performs control on the server apparatus 3. Further, the controller 31 includes an internal timer that measures time. The RAM 32 is a work area of the controller 31. The storage 33 is a storage area for storing programs and data. The controller 31 reads the program and the data from the RAM 32, and performs the program execution process based on the request information received from the terminal apparatus 5. The communication interface 34 can be connected to the communication network 2 wirelessly or by wire, and can receive data through the communication network 2. The data received through the communication interface 34 is loaded into the RAM 32, and arithmetic processing is performed by the controller 31.

Regarding the configuration of the terminal apparatus according to the eighth embodiment of the present invention, the contents described in FIG. 4 can be adopted within a necessary range. Regarding the program execution screen in the eighth embodiment of the present invention, the contents described in the fourth embodiment and the contents described in FIGS. 5 and 8 can be adopted within a necessary range. The program according to the eighth embodiment of the present invention may be, for example, a game program such as MMORPG, which is played by connecting a plurality of terminal apparatuses by communication through one or more server apparatuses.

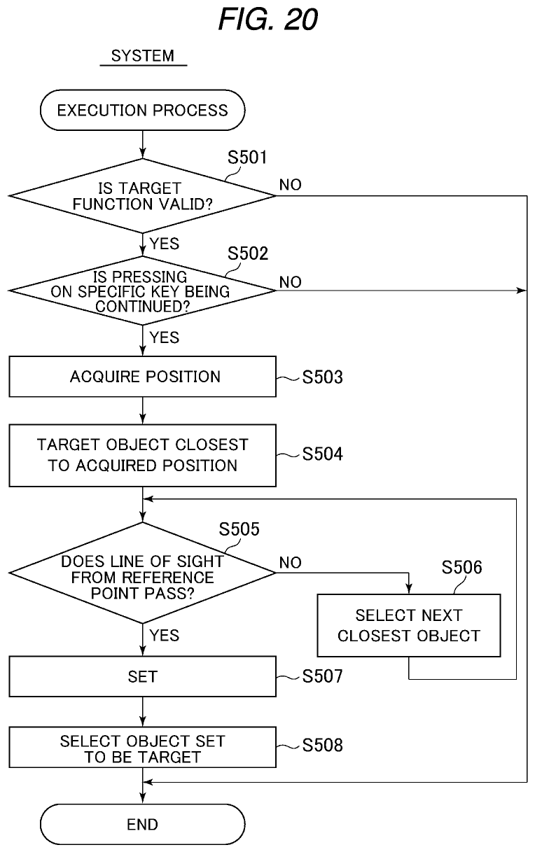

Next, functions of the system 4 will be described. FIG. 20 is a block diagram showing a configuration of a system corresponding to at least one of the embodiments of the present invention. The system 4 includes at least an attribute storage unit 1201, an image generating unit 1202, a function validity determining unit 1203, an operation continuation determining unit 1204, a position acquiring unit 1205, a distance calculation unit 1206, a first determining unit 1207, a second determining unit 1208, a target changing unit 1209, a setting unit 1210, and a selecting unit 1211.

The attribute storage unit 1201 has a function of storing the attribute of each object, which indicates whether or not the object in the three-dimensional virtual space can be selected. The image generating unit 1202 has a function of generating an image captured by imaging the inside of the three-dimensional virtual space using a virtual camera. The function validity determining unit 1203 has a function of determining whether or not a target function is valid. The operation continuation determining unit 1204 has a function of determining whether or not a predetermined input operation by the user is continuing. The position acquiring unit 1205 has a function of acquiring the position on the generated image, which is specified by the user through the input device.

The distance calculation unit 1206 has a function of calculating the distance between the position acquired by the position acquiring unit 1205 and the position of the object on the image. The first determining unit 1207 has a function of determining whether or not the position of the object in the three-dimensional virtual space on the generated image has a predetermined relationship with the position acquired by the position acquiring unit 1205. The second determining unit 1208 has a function of determining whether or not there is an obstacle object that blocks the line of sight from a reference point between the reference point and the object in the three-dimensional virtual space.

When it is determined that the object does not satisfy the predetermined condition, the target changing unit 1209 has a function of setting an object other than the object that has been the target of the determination as the determination target. The setting unit 1210 has a function of setting an object, which is determined by the first determining unit 1207 as having the predetermined relationship and is determined by the second determining unit 1208 as having no obstacle object, as an object selectable by the user. The selecting unit 1211 has a function of selecting an object that satisfies the predetermined condition.

The function included in the system 4 may be either the function of the server apparatus 3 or the function of the terminal apparatus 5. That is, the function may be distributively included, and the combination is not limited. Further, the process shown in the flowchart may be performed by either the server apparatus 3 or the terminal apparatus 5 as long as no contradiction or inconsistency occurs.

Next, an execution process will be described. As a premise, an attribute indicating whether or not selection is possible for each object present in the virtual space is stored by the attribute storage unit 1201 of the system 4. That is, objects are distinguished in advance between object that are selectable and objects that are not selectable. In addition, an image captured by imaging the inside of the three-dimensional virtual space using the virtual camera is generated by the image generating unit 1202, and the captured image is displayed on the display screen 23 of the terminal apparatus 5.

FIG. 20 is a flowchart of an execution process corresponding to at least one of the embodiments of the present invention. The system 4 determines whether or not the target function is valid (step S501). To make the target function valid, the function may be made valid on the setting (config) screen in advance. Regarding the setting screen, the contents described in the fourth embodiment can be adopted within a necessary range.

When the target function is invalid (NO in step S501), the process is terminated. When the target function is valid (YES in step S501), the system 4 determines whether or not the predetermined input operation is being continued by the operation continuation determining unit 1204 (step S502). Examples of the predetermined input operation include pressing of a specific key, continuous click operation at short intervals, and the like.

When it is determined that the predetermined input operation does not continue (NO in step S502), the process is terminated. When it is determined that the predetermined input operation is continuing (YES in step S502), the system 4 acquires the position on the generated image, which is specified by the user through the input device, by the position acquiring unit 1205, (step S503). Here, as an example, the input device is a mouse, and the position acquired in step S503 is the position specified by the mouse, that is, the position coordinate specified by the cursor 501 on the game screen 50.

Next, the system 4 extracts an object having a predetermined relationship with the position acquired by the position acquiring unit 1205, by the first determining unit 1207. The predetermined relationship refers to, for example, a relationship in which an object is located within a predetermined range from the position acquired in step S503. The predetermined range may be a range of a two-dimensional plane or in a three-dimensional space. The system 4 calculates the distance between the position acquired by the position acquiring unit 1205 and the position of the extracted object on the image, by the distance calculation unit 1206, and sets an object located at the acquired position, that is, closest to the position of the cursor 501 as a determination target of the second determining unit 1208 (step S504).

Next, the system 4 determines whether or not there is an obstacle object that blocks the line of sight from a reference point between the reference point and the object in the three-dimensional virtual space. (step S505). Here, as an example of the reference point, a viewpoint of a virtual camera that images the inside of a three-dimensional virtual space is taken. Regarding the blocking of the line of sight of the virtual camera, the contents described in the fourth embodiment and the contents described in FIGS. 9A to 9D and FIGS. 10A to 10D can be adopted within a necessary range.

When the line of sight does not pass from the reference point (NO in step S505), the system 4 sets an object other than the object that has been the target of the determination as a determination target by the target changing unit 1209 (step S506). More specifically, an object present at a position next closest to the position acquired in step S503 is set for a determination target. Then, it is again determined whether or not the line of sight passes from the reference point (step S505). The target object is changed in step S506 but when the line of sight does not pass from the reference point to all the objects having a predetermined relationship with the position acquired by the position acquiring unit 1205, the process may be terminated assuming that there is no selectable object.

When the line of sight passes from the reference point (YES in step S505), the system 4 sets the object that has been the determination target in step S505 as an object that is selectable by the user (step S507). Next, the system 4 automatically sets the set object to the selected state by the selecting unit 1211 (step S508), and the process is terminated.

As an example of the eighth embodiment, when the object as the determination target does not satisfy a predetermined condition, the next closest object is selected, but the present invention is not limited thereto. For example, the target may be changed based on a user operation.

As an example of the eighth embodiment, the selection state is automatically set after being set as a selectable object, but the present invention is not limited thereto. For example, the display mode may be changed such that the target candidate is emphasized and displayed without being selected. Alternatively, the selection may be made based on an operation instruction of the user.

As an example of the eighth embodiment, the line-of-sight direction of the virtual camera may be different from the line-of-sight direction of the character operating according to the operation instruction of the user.

As an example of the eighth embodiment, a case has been described in which the target function is made valid when setting is performed on the config screen and the predetermined input operation is continued, but the present invention is not limited thereto. For example, validity may be made only by setting the config screen, or may be made only by continuing a predetermined input operation.

Although the virtual space has been described as an example of the eighth embodiment, the present invention can be applied to the field of augmented reality (AR) that incorporates information of the real world.

Although the game program has been described as an example of the eighth embodiment, the present invention is not limited to games and applicable genres are not limited.

As an example of the eighth embodiment, the reference point for determining whether or not the line of sight passes is the viewpoint of the virtual camera, but the present invention is not limited thereto. For example, the reference point may be set for an object. As a specific example of setting the reference point for an object, the contents described in the fourth embodiment and the contents described in FIGS. 9A to 9D and FIGS. 10A to 10D can be adopted within a necessary range.

As an example of the eighth embodiment, an example in which a mouse is used as the input device has been described, but the present invention is not limited thereto. For example, a wearable device that detects the movement of the body of the user may be adopted as the input device. A device that reads the movement of the eyeball as the movement of the body may be adopted. Alternatively, a device that listens to the voice being uttered and operates the input position may be adopted.

As an example of the eighth embodiment, the example has been described in which the reference point is set for the user object, but the present application is not limited thereto. For example, the reference point may be set for the enemy object, or the reference point may be set for the stone object displaced in the virtual space. By changing the reference point to be set, operability of the user can be changed and preference can be improved.

As an aspect of the eighth embodiment, operability of the user can be improved.

As an aspect of the eighth embodiment, since the reference point in the second determining unit 1208 is the viewpoint of the virtual camera that images the inside of the three-dimensional virtual space, only visible objects can be selected in the captured image, and the user can operate intuitively, which makes it possible to improve the operability.

As an aspect of the eighth embodiment, since the reference point in the second determining unit 1208 is the viewpoint of the character that operates according to the operation instruction of the user in the three-dimensional virtual space, only objects visible by the user object in the virtual space can be selected, the virtual space can be made to feel more realistic, and immersive feeling of the user can be enhanced.

As an aspect of the eighth embodiment, with the facts that the computer apparatus includes the attribute storage unit 1201 and the object having the attribute indicating that it is selectable is a selectable object, an object having an attribute indicating that it is not selectable can be excluded from a selection candidate and only the selectable object can be selected without making a mistake, and thus operability of the user can be improved.

As an aspect of the eighth embodiment, since setting of the object by the setting unit 1210 can be implemented only when a predetermined condition is satisfied, setting can be made to match the preference of the user, and thus operability of the user can be improved.

As an aspect of the eighth embodiment, since setting of the object can be implemented by setting the attribute indicating whether or not implementation of the setting unit 1210 is possible to be implementable, setting can be made to match the preference of the user, and thus user operability can be improved.

As an aspect of the eighth embodiment, since setting of the object can be implemented by continuing the predetermined input operation by the user, setting can be made to match the preference of the user, and thus operability of the user can be improved.

As an aspect of the eighth embodiment, since the line-of-sight direction of the virtual camera and the line-of-sight direction of the character operating by the operation instruction of the user in the three-dimensional virtual space are different, the state of the user character can be objectively visible, and the visibility of the user can be improved, for example, the state behind the character can be visible.

As an aspect of the eighth embodiment, since the distance calculation unit 1206 and the selecting unit 1211 selecting an object are included, the operation of the user can be assisted, the operation load can be reduced, and the operability of the user can be improved.

As an aspect of the eighth embodiment, since the unit that switches the selection to an object different from the selected object based on the selecting unit 1211 and the input operation of the user is included, the selection can be switched at the timing of the user, and thus the operability of the user can be improved.

In the eighth embodiment, for each of “input device”, “computer apparatus”, “three-dimensional virtual space”, “object”, “position on the image”, “reference point”, “line of sight of virtual camera”, and “blocking the line of sight”, the contents described in the first embodiment can be adopted within a necessary range.

In the eighth embodiment, for each of “continuation of a predetermined input operation” and “bird's eye viewpoint”, the contents described in the fourth embodiment can be adopted within a necessary range. For each of the “terminal apparatus” and the “server apparatus”, the contents described in the fifth embodiment can be adopted within a necessary range.

### Appendix

The description of the embodiments described above has been described so that those having ordinary knowledge in the field to which the invention belongs can carry out the following invention.

[1] A program that is executed in a computer apparatus comprising an input device, the program causing the computer apparatus to function as:

an image generator that generates an image captured by imaging an inside of a three-dimensional virtual space using a virtual camera;

a position acquirer that acquires a position on the generated image, the position being specified by a user through the input device;

a first determiner that determines whether or not a position of an object in the three-dimensional virtual space on the generated image has a predetermined relationship with the position acquired by the position acquirer;

a second determiner that determines whether or not an obstacle object that blocks a line of sight from a reference point between the reference point and the object in the three-dimensional virtual space is present; and

a setter that sets the object, which is determined by the first determiner as having the predetermined relationship and is determined by the second determiner as not having the obstacle object, as an object selectable by the user.

[2] The program according to [1], wherein the reference point in the second determiner is a viewpoint of the virtual camera that images the inside of the three-dimensional virtual space.

[3] The program according to [1], wherein the reference point in the second determiner is a viewpoint of a character that acts according to an operation instruction of the user in the three-dimensional virtual space.

[4] The program according to any one of [1] to [3], wherein the program causes the computer apparatus to further function as

an attribute storage that stores an attribute which indicates whether or not the object in the three-dimensional virtual space is selectable for each object, and

the object having the attribute that indicates that the object is selectable is a selectable object.

[5] The program according to any one of [1] to [4], wherein the setting of the object by the setter is implementable only when a predetermined condition is satisfied.

[6] The program according to [5], wherein the predetermined condition is that an attribute indicating whether or not implementation of the setter is possible is set to be implementable.

[7] The program according to [5], wherein the predetermined condition is that a predetermined input operation by the user is continued.

[8] The program according to any one of [1] to [7], wherein a line-of-sight direction of the virtual camera is different from a line-of-sight direction of a character that acts in the three-dimensional virtual space according to an operation instruction of the user.

[9] The program according to any one of [1] to [8], wherein the program causes the computer apparatus to further function as:

a distance calculator that calculates a distance between the position acquired by the position acquirer and the position of the object set by the setter on the image; and

an auto-selector that, out of the objects set by the setter, selects an object at a position with the shortest distance from the position acquired by the position acquirer.

[10] The program according to any one of [1] to [9], wherein the program causes the computer apparatus to further function as:

a selector that selects an object set by the setter; and

a selection switcher that switches selection to an object different from the selected object based on a predetermined input operation by the user when a plurality of objects set by the setter is present.

[11] A computer apparatus comprising an input device, comprising:

an image generator that generates an image captured by imaging an inside of a three-dimensional virtual space using a virtual camera;

a position acquirer that acquires a position on the generated image, the position being specified by a user through the input device;

a first determiner that determines whether or not a position of an object in the three-dimensional virtual space on the generated image has a predetermined relationship with the position acquired by the position acquirer;

a second determiner that determines whether or not an obstacle object that blocks a line of sight from a reference point between the reference point and the object in the three-dimensional virtual space is present; and

a setter that sets the object, which is determined by the first determiner as having the predetermined relationship and is determined by the second determiner as not having the obstacle object, as an object selectable by the user.

[12] A control method in a computer apparatus comprising an input device, the control method comprising:

an image generator that generates an image captured by imaging an inside of a three-dimensional virtual space using a virtual camera;

a position acquirer that acquires the position on the generated image, the position being specified by a user through the input device;

a first determiner that determines whether or not a position of an object in the three-dimensional virtual space on the generated image has a predetermined relationship with the position acquired by the position acquirer;

a second determiner that determines whether or not an obstacle object that blocks a line of sight from a reference point between the reference point and the object in the three-dimensional virtual space is present; and

a setter that sets the object, which is determined by the first determiner as having the predetermined relationship and is determined by the second determiner as not having the obstacle object, as an object selectable by the user.

[13] A program that is executed in a server apparatus of a system comprising a terminal apparatus comprising an input device and the server apparatus connectable to the terminal apparatus by communication, the program causing the server apparatus to perform functions as:

an image generator that generates an image captured by imaging an inside of a three-dimensional virtual space using a virtual camera;

a position acquirer that acquires a position on the generated image, the position being specified by a user through the input device;

a first determiner that determines whether or not a position of an object in the three-dimensional virtual space on the generated image has a predetermined relationship with the position acquired by the position acquirer;

a second determiner that determines whether or not an obstacle object that blocks a line of sight from a reference point between the reference point and the object in the three-dimensional virtual space is present; and

a setter that sets the object, which is determined by the first determiner as having the predetermined relationship and is determined by the second determiner as not having the obstacle object, as an object selectable by the user.

[14] A server apparatus in which the program according to [13] is installed.

[15] A system that comprises a terminal apparatus comprising an input device and a server apparatus connectable to the terminal apparatus by communication, the system comprising:

an image generator that generates an image captured by imaging an inside of a three-dimensional virtual space using a virtual camera;

a position acquirer that acquires the position on the generated image, the position being specified by a user through the input device;

a first determiner that determines whether or not a position of an object in the three-dimensional virtual space on the generated image has a predetermined relationship with the position acquired by the position acquirer;

a second determiner that determines whether or not an obstacle object that blocks a line of sight from a reference point between the reference point and the object in the three-dimensional virtual space is present; and

a setter that sets the object, which is determined by the first determiner as having the predetermined relationship and is determined by the second determiner as not having the obstacle object, as an object selectable by the user.

[16] A program that is executed in a terminal apparatus of a system comprising the terminal apparatus comprising an input device and a server apparatus connectable to the terminal apparatus by communication, the program causing the terminal apparatus to function as:

an image generator that generates an image captured by imaging an inside of a three-dimensional virtual space using a virtual camera;

a position acquirer that acquires a position on the generated image, the position being specified by a user through the input device;

a first determiner that determines whether or not a position of an object in the three-dimensional virtual space on the generated image has a predetermined relationship with the position acquired by the position acquirer;

a second determiner that determines whether or not an obstacle object that blocks a line of sight from a reference point between the reference point and the object in the three-dimensional virtual space is present; and

a setter that sets the object, which is determined by the first determiner as having the predetermined relationship and is determined by the second determiner as not having the obstacle object, as an object selectable by the user.

[17] A terminal apparatus in which the program according to [16] is installed.

[18] A control method that is executed in a server apparatus of a system comprising a terminal apparatus comprising an input device and the server apparatus connectable to the terminal apparatus by communication, the control method comprising:

an image generator that generates an image captured by imaging an inside of a three-dimensional virtual space using a virtual camera;

a position acquirer that acquires the position on the generated image, the position being specified by a user through the input device;

a first determiner that determines whether or not a position of an object in the three-dimensional virtual space on the generated image has a predetermined relationship with the position acquired by the position acquirer;

a second determiner that determines whether or not an obstacle object that blocks a line of sight from a reference point between the reference point and the object in the three-dimensional virtual space is present; and

a setter that sets the object, which is determined by the first determiner as having the predetermined relationship and is determined by the second determiner as not having the obstacle object, as an object selectable by the user.

[19] A control method that is executed in a system comprising a terminal apparatus comprising an input device and a server apparatus connectable to the terminal apparatus by communication, the control method comprising:

an image generator that generates an image captured by imaging an inside of a three-dimensional virtual space using a virtual camera;

a position acquirer that acquires the position on the generated image, the position being specified by a user through the input device;

a first determiner that determines whether or not a position of an object in the three-dimensional virtual space on the generated image has a predetermined relationship with the position acquired by the position acquirer;

a second determiner that determines whether or not an obstacle object that blocks a line of sight from a reference point between the reference point and the object in the three-dimensional virtual space is present; and

a setter that sets the object, which is determined by the first determiner as having the predetermined relationship and is determined by the second determiner as not having the obstacle object, as an object selectable by the user.

1. A non-transitory computer-readable recording medium comprising a program that is executed in a computer apparatus comprising an input device, the program causing the computer apparatus to function as:
an image generator that generates an image captured by imaging an inside of a three-dimensional virtual space using a virtual camera;
a position acquirer that acquires a position on the generated image, the position being specified by a user through the input device;
a first determiner that determines whether or not a position of an object in the three-dimensional virtual space on the generated image has a predetermined relationship with the position acquired by the position acquirer;
a second determiner that determines whether or not an obstacle object that blocks a line of sight from a reference point between the reference point and the object in the three-dimensional virtual space is present; and
a setter that sets the object, which is determined by the first determiner as having the predetermined relationship and is determined by the second determiner as not having the obstacle object, as an object selectable by the user.

2. The non-transitory computer-readable recording medium according to claim 1, wherein the reference point in the second determiner is a viewpoint of the virtual camera that images the inside of the three-dimensional virtual space.

3. The non-transitory computer-readable recording medium according to claim 1, wherein the program causes the computer apparatus to further function as
an attribute storage that stores an attribute which indicates whether or not the object in the three-dimensional virtual space is selectable for each object, and
the object having the attribute that indicates that the object is selectable is a selectable object.

4. The non-transitory computer-readable recording medium according to claim 1, wherein the setting of the object by the setter is implementable only when a predetermined condition is satisfied.

5. The non-transitory computer-readable recording medium according to claim 4, wherein the predetermined condition is that an attribute indicating whether or not implementation of the setter is possible is set to be implementable.

6. The non-transitory computer-readable recording medium according to claim 4, wherein the predetermined condition is that a predetermined input operation by the user is continued.

7. A computer apparatus comprising an input device, comprising:
an image generator that generates an image captured by imaging an inside of a three-dimensional virtual space using a virtual camera;
a position acquirer that acquires a position on the generated image, the position being specified by a user through the input device;
a first determiner that determines whether or not a position of an object in the three-dimensional virtual space on the generated image has a predetermined relationship with the position acquired by the position acquirer;
a second determiner that determines whether or not an obstacle object that blocks a line of sight from a reference point between the reference point and the object in the three-dimensional virtual space is present; and
a setter that sets the object, which is determined by the first determiner as having the predetermined relationship and is determined by the second determiner as not having the obstacle object, as an object selectable by the user.

8. A control method in a computer apparatus comprising an input device, the control method comprising:
generating an image captured by imaging an inside of a three-dimensional virtual space using a virtual camera;
acquiring the position on the generated image, the position being specified by a user through the input device;
first determining whether or not a position of an object in the three-dimensional virtual space on the generated image has a predetermined relationship with the position acquired by the position acquirer;
second determining whether or not an obstacle object that blocks a line of sight from a reference point between the reference point and the object in the three-dimensional virtual space is present; and
setting the object, which is determined by the first determining as having the predetermined relationship and is determined by the second determining as not having the obstacle object, as an object selectable by the user.

9. The non-transitory computer-readable recording medium according to claim 1, wherein the reference point in the second determiner is a viewpoint of a character that acts according to an operation instruction of the user in the three-dimensional virtual space.

10. The non-transitory computer-readable recording medium according to claim 1, wherein a line-of-sight direction of the virtual camera is different from a line-of-sight direction of a character that acts in the three-dimensional virtual space according to an operation instruction of the user.

11. The non-transitory computer-readable recording medium according to claim 1, wherein the program causes the computer apparatus to further function as:
a distance calculator that calculates a distance between the position acquired by the position acquirer and the position of the object set by the setter on the image; and
an auto-selector that, out of the objects set by the setter, selects an object at a position with the shortest distance from the position acquired by the position acquirer.

12. The non-transitory computer-readable recording medium according to claim 1, wherein the program causes the computer apparatus to further function as:
a selector that selects an object set by the setter; and
a selection switcher that switches selection to an object different from the selected object based on a predetermined input operation by the user when a plurality of objects set by the setter is present.
